(19) United States
(12) Patent Application Publication
(10) Pub. No.: US 2012/0227178 A1
(43) Pub. Date: Sep. 13, 2012

(54) Sauna Device

(76) Inventor: Seung Woo LEE, Yorba Linda, CA (US)

(21) Appl. No.: 13/230,600

(22) Filed: Sep. 12, 2011

(30) Foreign Application Priority Data
Sep. 13, 2010 (KR) 10-2010-0089642

(51) Int. Cl. A61H 33/06

(52) U.S. Cl. 4/524

(57) ABSTRACT

The sauna device includes a sauna room enclosed by a floor and a wall forming a box shape, a first heating body installed on the wall such that a user enters the sauna room and receives the radiating heat, a chair provided in a lower front portion of the first heating body and including a seat and a back plate, and a second heating body received in the back plate, which can increase the quality of the sauna drastically since the non-heating portion can be complimented through heating body embedded in the waist support and delivers radiating heat to the hip portion effectively.

### BACKGROUND OF THE INVENTION

The present invention relates to a sauna device, and more specifically to a sauna device for whole body, in which a user enter a sauna room and enjoy.

In general, the sauna provides a heating body in a predetermined space to increase air temperature therein or provides steam of high temperature, such that users expose their bodies in that space and perspires. The sauna includes a dry-type and a wet-type saunas, and the dry-type saunas include a high-temperatue (Finnish) sauna and a low-temperature (far-infrared) sauna. Recently, as people get more interested in health, a booth-type sauna for one or two persons was made and instroduced to home or commercial sauna facilities. Among them, since it is very safe, saves space, and emits far infrared radiation, a dry-type sauna using a planar heating body that emits heat evenly from the entire surface was used widely.

FIGS. 1 and 2 are a perspective view and a front view showing a sauna device of prior arts, and the following explanation refers to the fingures.

A sauna room comprises a bottom plate (1), a door (8) provided on the front surface, a front plate (2) installed on a top surface of the bottom plate (1), a rear plate (30) installed behind the front plate (2) with an interval, left and right plates (4, 5) installed in the left and right of the top surface of the bottom plate (1), and a ceiling plate (5) put on the top surfacs of the front and rear plates (2, 3) and the left and right plate (4, 5), and a chair (7) for the user is installed inside the wall structure, which includes a seat (7-1) and a back plate (7-2), and a heating body (8) is installed in the sauna room and and receives electrical power and emits heat.

Exlaining briefly the above sauna devices of prior arts, if controlling the control portion (not shown) installed in front or rear surface of the front plate (20), the electrical powere is delivered to the heating body (8), the heating body (8) receives the electrical power and emits heat so as to emit the radiation toward the user, and the user can enjoy the sauna with raidative heat as a medium.

However, in the case of conventional sauna device, as shown in FIG. 2, a radiating heat from the heating body (8) is blocked by the back plate (7-2), resulting a non-heating portion (A), and when the user sits on the seat (7-1) of the chair (7), the user's back portion and head portion can be exposed to the radiating heat from the heating body (8) through the heaitng portions, but the hip portion is not exposed to the radiating heat from the heating body (8) because of the non-heating portion (A) by the back plate (7-2), such that there has been a problem for improving the non-heating portion (A) while keeping the back plate (7-2).

Accordingly, a need for a sauna device has been present for a long time considering the expansive demands in the everyday life. This invention is directed to solve these problems and satisfy the long-felt need.

### SUMMARY OF THE INVENTION

The present invention contrives to solve the above disadvantages of the prior art, in which the goal is to deliver the radiating heat to the hip portion while keeping the back plate through improiving the non-heating portion and to provide a whole-body sauna device enabling a long-hours of sauna.

The sauna device comprises: a sauna room enclosed by a floor and a wall forming a box shape; a first heating body installed on the wall such that a user enters the sauna room and receives the radiating heat; a chair provided in a lower front portion of the first heating body and including a seat and a back plate; and a second heating body received in the back plate.

In the present invention, the sauna device comprises a back-plate-fixing frame disposed on the wall on which the first heating body is installed, such that the waist support it attached or detached.

In the present invention, the back-plate-fixing frame is installed over the first heating body, and may furhter comprises a neck support for supporting the neck portion of the user sitting on the chair, wherein the neck support is attached and detached to the back-plate-fixing frame.

In the present invention, the neck support is configured to be attached or detached through magnets so as to adjust the position according to the user's body dimension.

In the present invention, the sauna device may further comprise: a heating room comprising an air-intake hole for taking in external air, a third planar heating body for heating the floor and the introduced air, an air-release hole for taking out air heated by the third heating body, and a guiding groove portion for guiding the third heating body to be inserted and fixed slidingly; and an open-close plate installed slidingly on the floor so as to adjust air flow by opening or closing corresponding to the air-release hole.

The whole-body sauna device according to the invention can improve a non-heating portion, deliver radiating heat effectively to the hip portion, and increase the quality of sanua by embedding a heating body in the back plate.

Also, by installing a neck support on a back-plate-fixing frame by means of magnets, the sauna device according to the invention enables adjusting the height of position of the neck of the user, such that a user having short sitting posture can enjoy the sauna conveniently.

Additionally, by forming waist support and neck support in the back-plate-fixing frame detachably, since it reduces the size of package in packaging in the back-plate-fixing frame, it can reduce the cost of distribution in packaging and transportation.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIGS. 1 and 2 are a perspective view showing a conventional sauna device and a front view showing a state with a front plate detached;

FIGS. 3 and 4 are an assembled perspective view and an exploded perspective view showing a whole-body sauna device according to the invention;

FIGS. 5 and 6 are a front view and a side cross-sectional view showing an whole-body sauna device with a front plate detached according to the invention;

FIGS. 7 and 8 are an assembled perspective view and an exploded perspective view showing a whole-body sauna device with a waist support detached according to the invention;

FIGS. 9 and 10 are an assembled perspective view and an exploded perspective view showing a whole-body sauna device with a floor detached according to the invention; and

FIG. 11 is a diagram showing usage of an whole-body sauna device according to the invention.

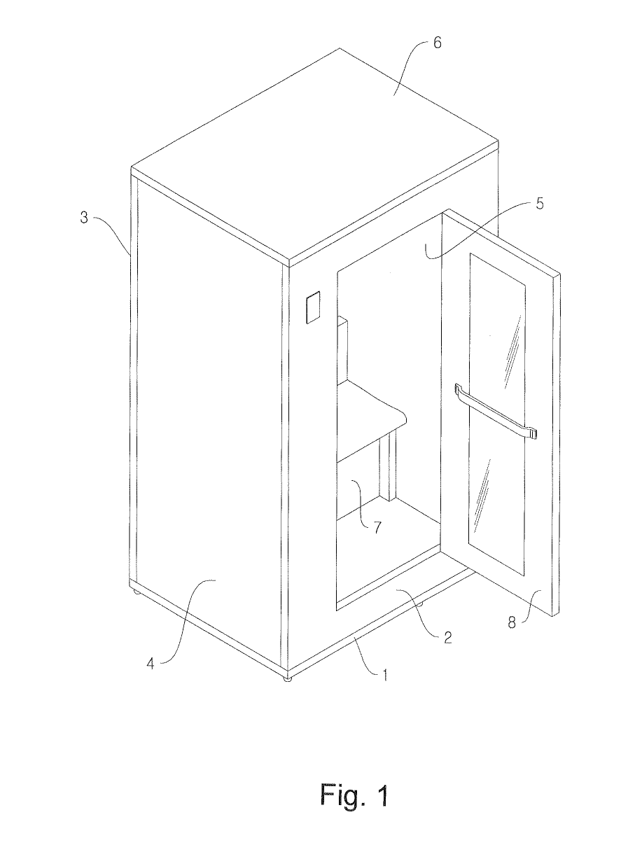

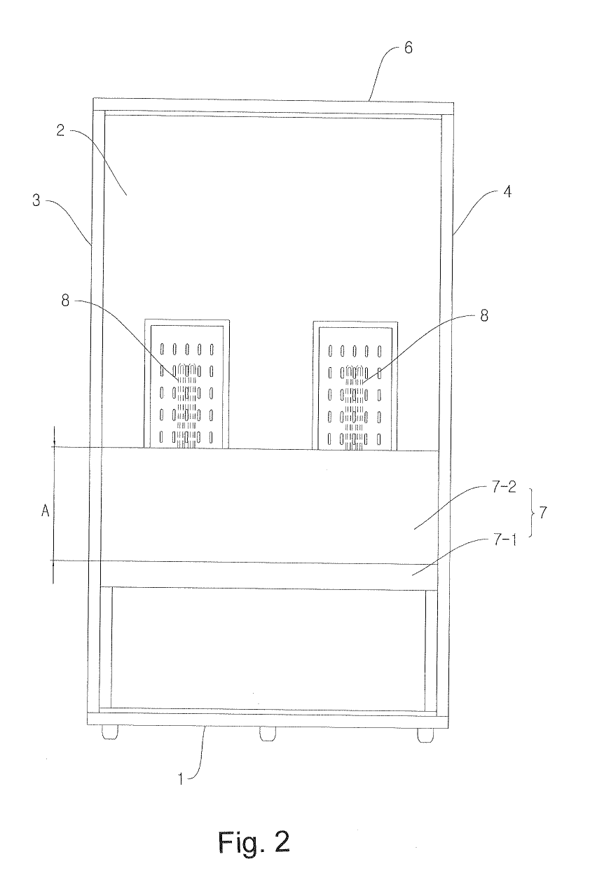

### DETAILED DESCRIPTION EMBODIMENTS OF THE INVENTION

This application claims priority to Korean Patent App. Ser. No. 10-2010-0089642 filed Sep. 13, 2010, all of which are hereby incorporated by reference.

Below, an whole-body sauna device according to the invention is described in detail referring to the figures.

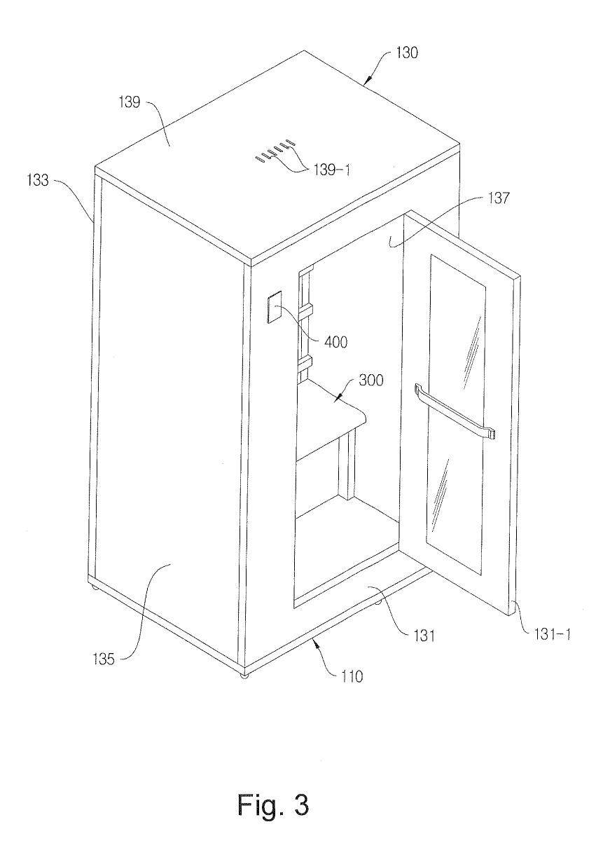

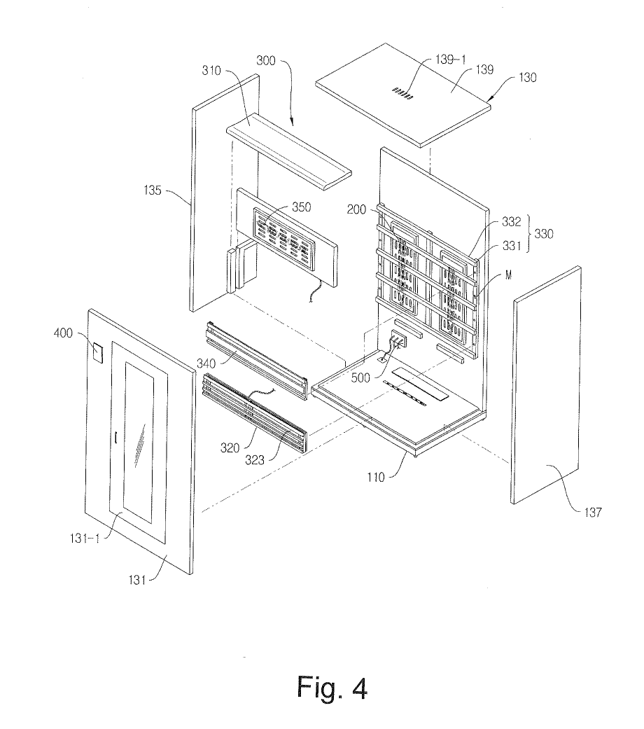

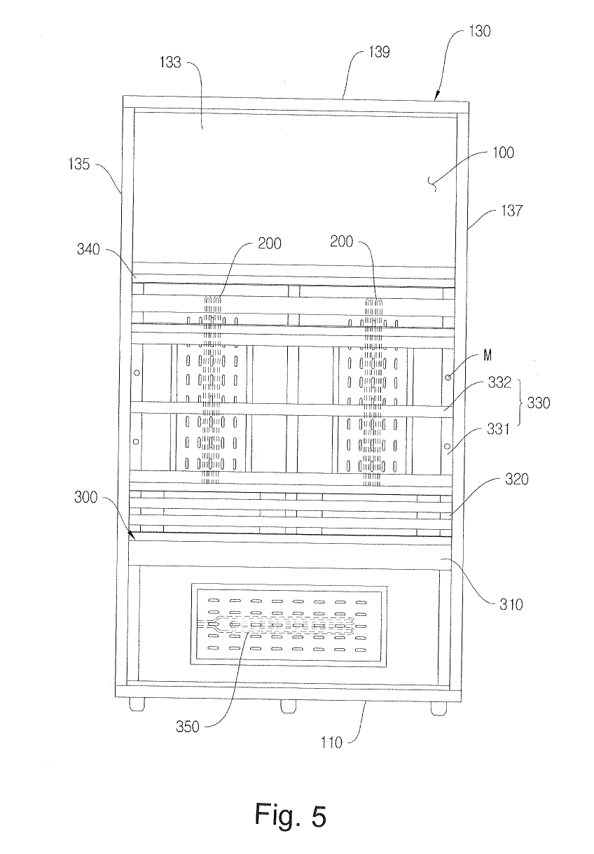

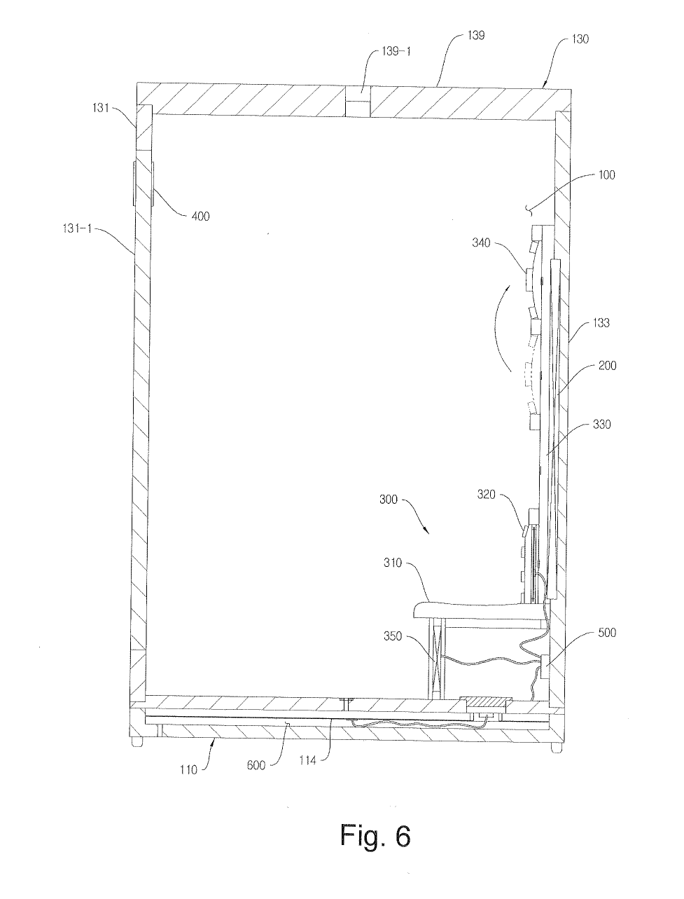

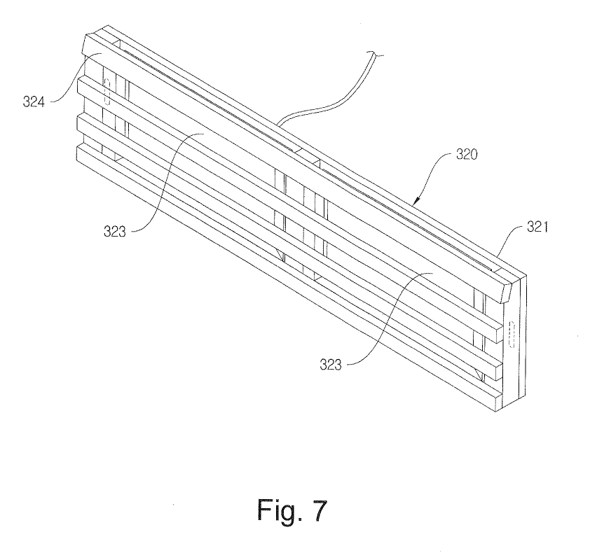

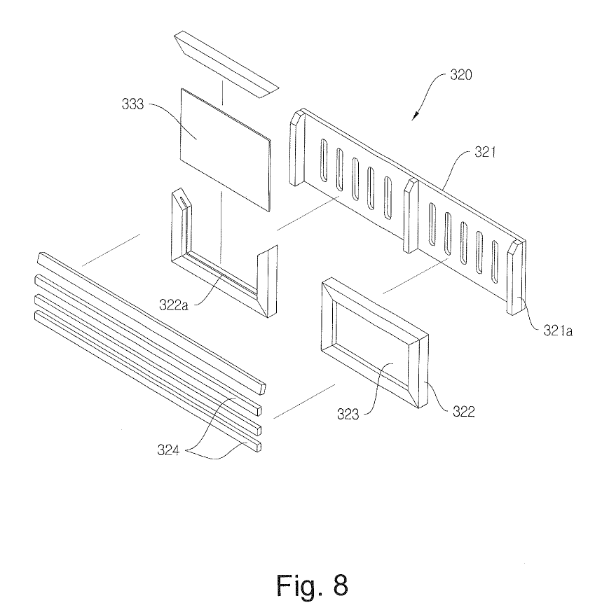

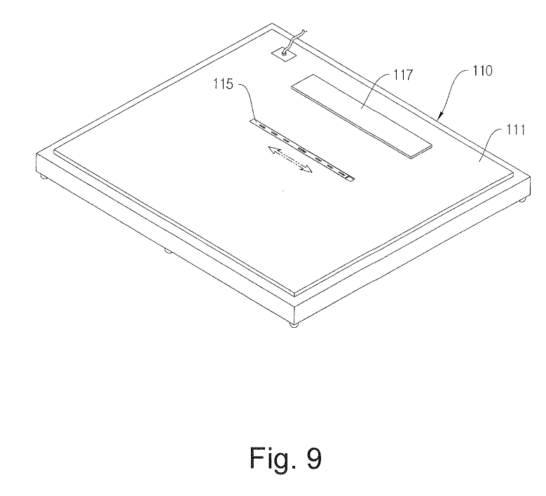

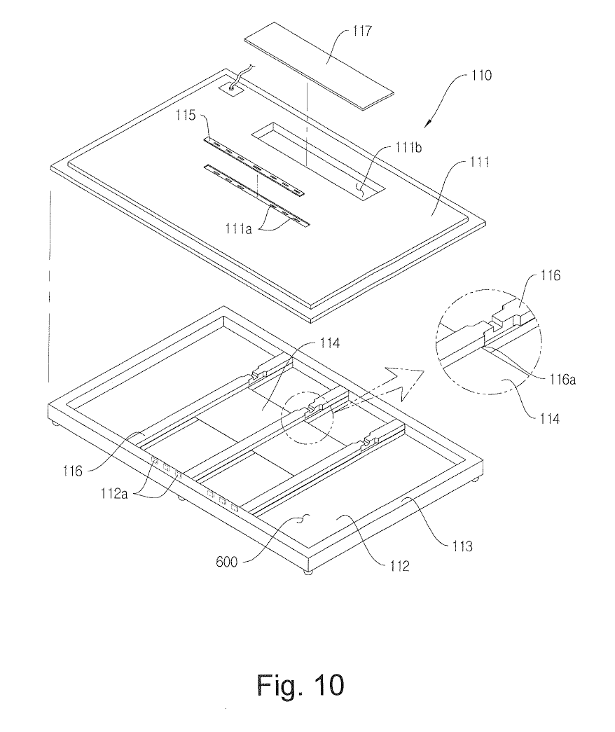

FIGS. 3 and 4 are an assembled perspective view and an exploded perspective view showing a whole-body sauna device according to the invention, FIGS. 5 and 6 are a front view and a side cross-sectional view showing an whole-body sauna device with a front plate detached according to the invention, FIGS. 7 and 8 are an assembled perspective view and an exploded perspective view showing a whole-body sauna device with a waist support detached according to the invention, and FIGS. 9 and 10 are an assembled perspective view and an exploded perspective view showing a whole-body sauna device with a floor detached according to the invention.

Describing the whole-body sauna device according to the invention referring to FIGS. 3-8, the whole-body sauna device comprises: a sauna room (100) enclosed by a floor (110) and a wall (130) forming a box shape; a first heating body (200) installed on the wall such that a user enters the sauna room (100) and receives radiating heat; a chair (300) disposed in a lower front portion of the first heating body (200) such that the user enters and sits on and comprising a seat (310) and a back plate (320); and a second heating body (333) received in the back plate (320).

The floor (110) is going to explained in detail later, and the wall (130) is described below.

The wall (130) is for providing a closed space formed along with the floor (110) and obtained and by enclosing top of the floor (110), and comprises a front plate (131), a rear plate (133), a left side plate (135), a right side plate (137), and a ceiling plate (139), and a entrance (131-1) is attached in the front plate (131) such that the user enters inside.

And, in the front plate (131) are installed controllers (400) for controlling the operation of the heating body inside and outside.

In this embodiment, the floor (110) and the wall (130) are described as a sauna room (100) of a box shape having six-faces, but that is just for an embodiment of the invention, and the sauna room (100) forming a box can be made in various shapes, for example, a box having a hemi-spherical wall formed over the floor (110).

On the other hand, the floor (110), front plate (131), rear plate (133), left side plate (135), right side plate (137), and ceiling plate (139) are assembled with one another with fastening means, for example, fastening brackets, each having a fastening latch on one end and a fastening protrusion on the other end, which are installed in the floor (110), the front and rear plates (131, 132), the right and left plates (135, 137), and the ceiling plate (139) respectively and fasten to one another firmly.

In a lower portion of the rear plate (133) is installed a power supply (500) for supplying electrical power to the heating bodies (200, 323, 330, 114), the power supply (500) is enclosed and protected by the chair (300). For an example, the power supply (500) is shown to be installed in the rear plate (133), but it is just an example, for example, the power supply (500) may be installed in the floor (110), front plate (131), left side plate (135), or right side plate (137) according to necessity.

In the ceiling plate (139) forming the wall (130) is formed a venting hole (139-1) for being connected to the insauna room (100) and venting internal dry air to outside, and the in the venting hole (139-1) may be preferably installed a open/close plate for opening and closing according to the user's control.

Also, in the ceiling plate (139) may be installed an illuminating device or an audio device, so as to enable enjoying sauna listening to music in a bright environment.

The first heating body (200) may be a pole-type heater, which includes far-infrared material therein, is supplied with electrical power, and emits infrared ray and radiating heat to outside.

In this embodiment, the first heating body (200) is installed in the rear plate (133) exposedly, and is protected by a blocking cover formed with a plurality of holes.

The chair (300) disposed in a front lower portion of the first heating body (200) so as to allow the user to enter and sit on includes the seat (310) and the back plate (320), and in the back plate (320) is embedded a second heating body (323) for receiving electrical power and emitting heat.

The back plate (320) includes: a base plate (321) having a plurality of strengthening piece (321a) and installed in the back-plate-fixing frame (330) detachably; a fixing frame (322) having a slit groove (322a) and installed in front of the base plate (321); a second heating body (323) that is inserted and fixed in the slit groove (322a) of the fixing frame (322) and generates heat with electrical power supplied; and a plurality of blocking bars (324) installed horizontally in the strengthening piece (321a) of the base plate (321) in a length direction.

In the rear plate (133), in which the first heating body (200) is installed, is installed the back-plate-fixing frame (330), and the back-plate-fixing frame (330) is installed extendingly toward a top of the first heating body (200), and a neck support (340) is installed in the back-plate-fixing frame (330) such that the user enters and has his or her neck portion supported.

In this embodiment, the back-plate-fixing frame (330) the back-plate-fixing frame (330) includes a plurality of vertical bars (331) disposed vertically to the rear plate (133) with intervals and a plurality of horizontal bars (332) disposed on the front side in a length direction of the vertical bar (331) with equal intervals, and between the vertical bar (331) and vertical bar (331) are installed the back plate (320) embedded with the second heating body (323) and neck support (340) detachably through a detaching means.

In this embodiment, the detaching means includes a magnet (M) and a metal piece corresponding to it, and the magnet and the metal piece may be installed anywhere in the vertical bar (331), back plate (320), and neck support (340), and since other detaching means can be used it is not limited to them.

Especially, the neck support (340) may preferably be attached or detached to the back-plate-fixing frame (330) through the magnet (M) so as to adjust the position according to the user's physical conditions.

According to the embodiment, when an old or sick person or a child enters the sauna room (100) to enjoy the sauna and sits on the seat (310) of the chair (300) their sitting heights may be different, the neck support (340) may be moved and adjusted to the position of neck of the old or sick person or child, allowing the user to enjoy the sauna in a more convenient condition.

On the other hand, in the lower portion of the chair (300) is added a fourth heating body (350) performing an equivalent function to the first heating body (200), and the fourth heating body (350) may also by a pole-type heater, which includes far-infrared material inside, is supplied with electrical power, and emits infrared ray or radiating heat to the outside.

As described in the above, inside the floor (110) is provided a heating room (600), and this is going to be explained referring to FIGS. 9 and 10.

The floor (110) includes a top plate (111), a bottom plate (112), and arectangular frame (113) disposed between the top plate (111) and bottom plate (112) and forming a space inside.

And, in the bottom plate (112) and the top plate (111) are formed an air-vent hole (112a) and an air-intake hole (111a) respectively, such that external air is introduced into the sauna room (100), and between the bottom plate (112) and top plate (111) is installed a hird heating body (114) for heating the introduced external air.

In this embodiment, the air-vent hole (112a) is described and shown to be formed in the bottom plate (112), but it is just an example, and since the air-vent hole (112a) can be formed in therectangular frame (113) according to necessity, it is not to be limited to them.

In the air-intake hole (111a) and air-vent hole (112a) may be preferably installed a filter such as a filterning net for preventing debries from being introduced.

The second heating body (323) and hird heating body (114) are a planar heating bodies, a sheet-type heating body, in which electrodes are attached to both sides and polymner insulators are layered on both surfaces.

Especially, the hird heating body (114) delivers heat source toward a bottom surface of the top plate (111) in addition to heat external air, and since the top plate (111) is heated up naturally through thermal conduction a cold feeling to the feet stepping into the sauna room (100) initially can be gotten rid of.

And, the installation location of the hird heating body (114) is preferably disposed at a position where the user's feet rest when the user sits on the chair (300).

On the other hand, a open/close plate (115) is installed slidingly correspondingly to the air-intake hole (111a) formed in the top plate (111) for controlling the amount of air.

According to the embodiment, if the internal air is determined to be murky during the sauna, the user can control the open/close plate (115) so as to introduce external air to the sauna room (100), having the murky air mixed with the external air with natural convecition to be refreshed.

Therefore, the user of the sauna room (100) can enjoy the sauna in a more refreshing environment.

Furthermore, if opening the venting hole (139-1) of the ceiling plate (139) forming the wall (130) additionally, the murky air can be vented to the outside more rapidly.

And, in the floor (110) is provided a guiding groove (116a), such that the hird heating body (114) is inserted aand fixed slidingly therein.

In this embodiment, the heating-body-fixing members (116) in which the guiding groove (116a) is formed in a length direction thereof are installed on the top of the bottom plate (112) side by side, and in the guiding grooves (116a) of the heating-body-fixing members (116) installed side by side is inserted and fixed the hird heating body (114).

And, on the top plate (111) forming the floor (110) are formed the openings (116b) to which the first heating body (200) and the sauna room (100) are connected, such that the hird heating body (114) is inserted or extracted through the sauna room (100), and in the opening (116b) is installed a cover (117) that is installed detachably.

According to this embodiment, when it is needed to replace the hird heating body (114) due to worn-out or malfunction, the hird heating body (114) fixed to the heating-body-fixing member (116) is extracted while the cover (117) covering the opening (116b) is detached, and a new hird heating body (114) is inserted for replacement.

Therefore, the convenience of the work may be increased by much since it is possible to replace or repair the hird heating body (114) through the opening (116b) and the cover (117) that is detachably installed in the opening (116b) in cases of deterioration or manfucntion of the hird heating body (114).

And, in the hird heating body (114) is preferably installed a bi-metal for deforming thermally and closing or opening the supply of electrical power to the hird heating body (114) when the temperature is increased over a predetermined temperature.

The operation of the above embodiment of the invention is going to be described below.

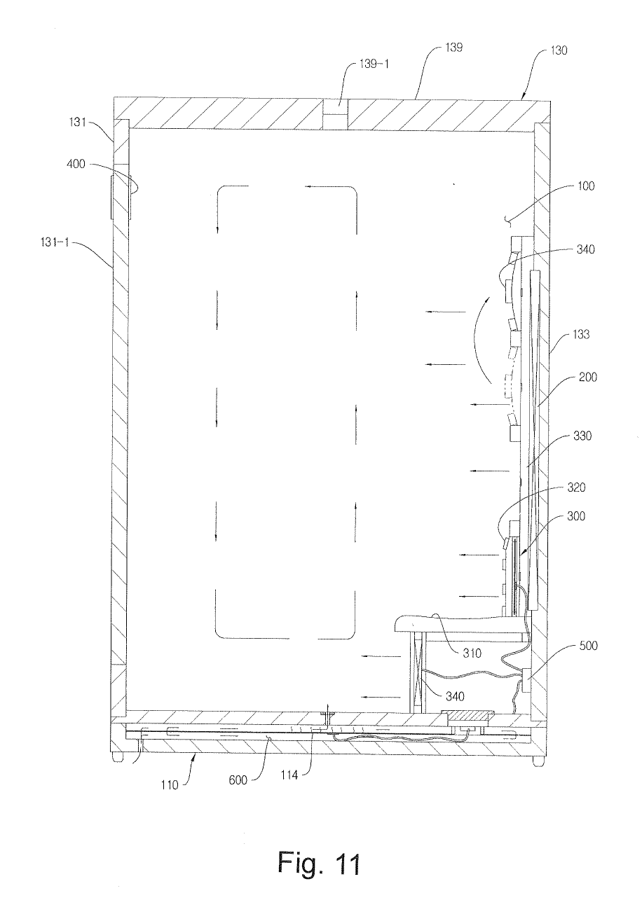

Referring to FIG. 11, first of all, if operating the controller (400) installed in the front plate (131), electrical power is supplied to the first heating body (200) and second heating body (323) and the hird heating body (114) and fourth heating body (350), respectively, generating heat, and the first heating body (200), second heating body (323), and fourth heating body (350) warm the air of the sauna room (100), and the hird heating body (114) warms the external air introduced through the air-vent hole (112a) and the lower surface of the top plate (111) forming the floor (110).

Especially, since the floor (110) is kept in a little warm condition, the user does not feel the floor cold when entering the sauna room (100) and can enter the sauna conveniently.

And, after a predetermined time, the user can open the entrance (131-1), enter the sauna room (100), and then enjoy the sauna.

On the other hand, if the heights of the neck and the a neck support (340) are not matched to each other when the user sits on the seat (210) of the chair (300) and leans to the back-plate-fixing frame (330) installed in the back plate (320), the neck support (340) is adjusted to match the height of the neck and then installed on the back-plate-fixing frame (330) while the neck support (340) attached to the back-plate-fixing frame (330) by means of magnets is loosened.

And, if determined that the internval air of the sauna room (100) is murky during the sauna, the open/close plate (115) provided in the floor (110) is opened, such that the heated external air is introduced into the sauna room (100) througyh the air-intake hole (111a), purifying the murky air.

Furthermore, if determined that the murky air was not purified completely, the opening (130-1) formed in the ceiling plate (139) is opened and the heated external air is introduced through the air-intake hole (111a) continuously to facilitate venting of the murky air, which enables purifying air in the sauna room (100) through convection more conveniently.

On the other hand, when the hird heating body (114) needs to be replaced during the sauna due to worn-out and malfunction, the cover (117) sealing the opening (116b) is opened, the hird heating body (114) fixed to the heating-body-fixing member (116) is extracted, and then a new hird heating body (114) is inserted for replacement.

Therefore, since as in the above it is easy to replace or repair the hird heating body (114) through the opening (116b) and the cover (117) installed detachably in the opening (116b) in cases of deterioration or malfunction, it is possible to increase the convenience of the works.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A sauna device comprising:
a sauna room enclosed by a floor and a wall forming a box shape;
a first heating body installed on the wall such that a user enters the sauna room and receives the radiating heat;
a chair provided in a lower front portion of the first heating body and including a seat and a back plate; and
a second heating body received in the back plate.

2. The sauna device of claim 1, further comprising:
a heating room comprising an air-intake hole for taking in external air, a third planar heating body for heating the floor and the introduced air, an air-release hole for taking out air heated by the third heating body, and a guiding groove portion for guiding the third heating body to be inserted and fixed slidingly; and
an open-close plate installed slidingly on the floor so as to adjust air flow by opening or closing corresponding to the air-release hole.

3. The sauna device of claim 1, further comprising a back-plate-fixing frame disposed on the wall on which the first heating body is installed, such that the waist support it attached or detached.

4. The sauna device of claim 3, further comprising:
a heating room comprising an air-intake hole for taking in external air, a third planar heating body for heating the floor and the introduced air, an air-release hole for taking out air heated by the third heating body, and a guiding groove portion for guiding the third heating body to be inserted and fixed slidingly; and
an open-close plate installed slidingly on the floor so as to adjust air flow by opening or closing corresponding to the air-release hole.

5. The sauna device of claim 3, wherein the back-plate-fixing frame is extended and installed toward a top portion of the first heating body, and furhter comprising a neck support for supporting the neck portion of the user sitting on the chair, wherein the neck support is attached and detached to the back-plate-fixing frame.

6. The sauna device of claim 5, further comprising:
a heating room comprising an air-intake hole for taking in external air, a third planar heating body for heating the floor and the introduced air, an air-release hole for taking out air heated by the third heating body, and a guiding groove portion for guiding the third heating body to be inserted and fixed slidingly; and
an open-close plate installed slidingly on the floor so as to adjust air flow by opening or closing corresponding to the air-release hole.

7. The sauna device of claim 5, wherein the neck support is attached or detached through magnets so as to adjust the position according to the user's body dimension.

8. The sauna device of claim 7, further comprising:
a heating room comprising an air-intake hole for taking in external air, a third planar heating body for heating the floor and the introduced air, an air-release hole for taking out air heated by the third heating body, and a guiding groove portion for guiding the third heating body to be inserted and fixed slidingly; and
an open-close plate installed slidingly on the floor so as to adjust air flow by opening or closing corresponding to the air-release hole.
